(19) United States
(12) Patent Application Publication
(10) Pub. No.: US 2024/0116116 A1
(43) Pub. Date: Apr. 11, 2024

(54) MOBILE RESURFACING MACHINE

(71) Applicants: Paul J. Browning, Morrilton, AR (US); Paul M. Browning, Morrilton, AR (US)

(72) Inventors: Paul J. Browning, Morrilton, AR (US); Paul M. Browning, Morrilton, AR (US)

(21) Appl. No.: 17/961,096

(22) Filed: Oct. 6, 2022

(51) Int. Cl. B23B 35/00

(52) U.S. Cl. CPC B23B 35/00

(57) ABSTRACT

A mobile resurfacing machine for resurfacing the interior of cylinders in via boring. The machine has a cradle assembly which is attached to the cylinder opening of the fluid end module of a drilling mud pump and further has a powered, rotating cutting assembly which is mechanically advanced into the cylinder opening which is to be resurfaced such that the surface is bored to the desired specification.

### BACKGROUND OF THE INVENTION

The present invention is in the portable machine tools. More particularly, the present invention is in the technical field of portable machine tools for hole boring and resurfacing.

In the drilling industry, drilling mud is pumped into the hole to aid in the drilling process. This process requires large, high-pressure pumps which consist of a power end and a fluid end. The fluid end is the portion of the pump that is in contact with the drilling mud and causes it to be pumped. Typical pumps are positive displacement pumps with a cylinder and piston mechanism. For proper function of the fluid end, there needs to be a tight tolerance between the cylinder and the piston. The drilling mud, by its nature, is abrasive and will erode the cylinder after sufficient use. Once the cylinder is eroded to a certain point, the pump will not properly function. The options for correcting this are to replace the fluid end module or to repair the erosion. Due to the high cost of the fluid end module, repair is desirable.

Conventional methods for repair to the cylinder involve welding the interior of the cylinder to replace the worn metal and then mechanically removing any excess metal added in the welding process. The best method in removing the excess material is to have the cylinder machined to the proper dimension. However, this requires removing the module from the mud pump and taking it to a machine shop. The removal of the module renders it necessary to have a second module ready to utilize or the mud pump to be out of operation which results in excessive down time for the drilling rig. To avoid the expense of a spare fluid end module and excess downtime, the conventional method for removing excess is to grind the weld down with portable grinders. This drawbacks to this method are that it is imprecise and results in a repair with less longevity.

The present invention is a mobile resurfacing machine which is designed to mate with the fluid end module and precisely bore the cylinder to the specified dimension. The present invention is portable and can be used in the field without removing the fluid end module from the mud pump.

### SUMMARY OF THE INVENTION

The present invention is a mobile resurfacing machine which is designed to machine the cylinder of a fluid end module of a drilling mud pump. The machine utilizes a flange to mate with the cylinder and then utilized a rotating cutting head which is advanced into the cylinder with a rough cutting cartridge followed by a finishing cartridge to bore the cylinder to a uniform circle of precise dimension. The rotating cutting head is powered by an external motor.

The advantages of the present invention include, that it provides for an expedient and proper repair in the field to worn fluid end modules such that the operator can avoid costly replacements and downtime to drilling rigs.

### BRIEF DESCRIPTION OF THE DRAWINGS

These and other features, aspects, and advantages of the present invention will become better understood with regard to the following description, claims, and accompanying drawings where:

FIG. 1 is a front right perspective view of a mobile resurfacing machine of the present invention;

FIG. 2 is a left view of a mobile resurfacing machine of the present invention;

FIG. 3 is a rear right perspective view of a mobile resurfacing machine of the present invention;

FIG. 4 is a rear left perspective view of a mobile resurfacing machine of the present invention.

FIG. 5 is close up view of portions of a transmission assembly and cutting assembly showing the placement of a drive link;

FIG. 6 is a side view of an outside flange;

FIG. 7 is a rear view of an outside flange;

FIG. 8 is a side view of a mounting flange;

FIG. 9 is a rear view of a mounting flange;

FIG. 10 is a rear view of a rear bearing plate;

FIG. 11 is a front perspective view of a rear bearing plate;

FIG. 12 is a rear view of a forward bearing plate;

FIG. 13 is a front perspective view of a forward bearing plate;

FIG. 14 is a front end view of a cutting head assembly;

FIG. 15 is a side view of a cutting head assembly and drive shaft;

FIG. 16 is a right side view of a cutting head assembly's central insert holder;

FIG. 17 is an end view of a cutting head assembly's central insert holder;

FIG. 18 is a left side view of a cutting head assembly's central insert holder;

FIG. 19 is a bottom perspective view of a cutting cartridge holder; and

FIG. 20 is an end view of a cutting cartridge holder.

### DETAILED DESCRIPTION OF THE INVENTION

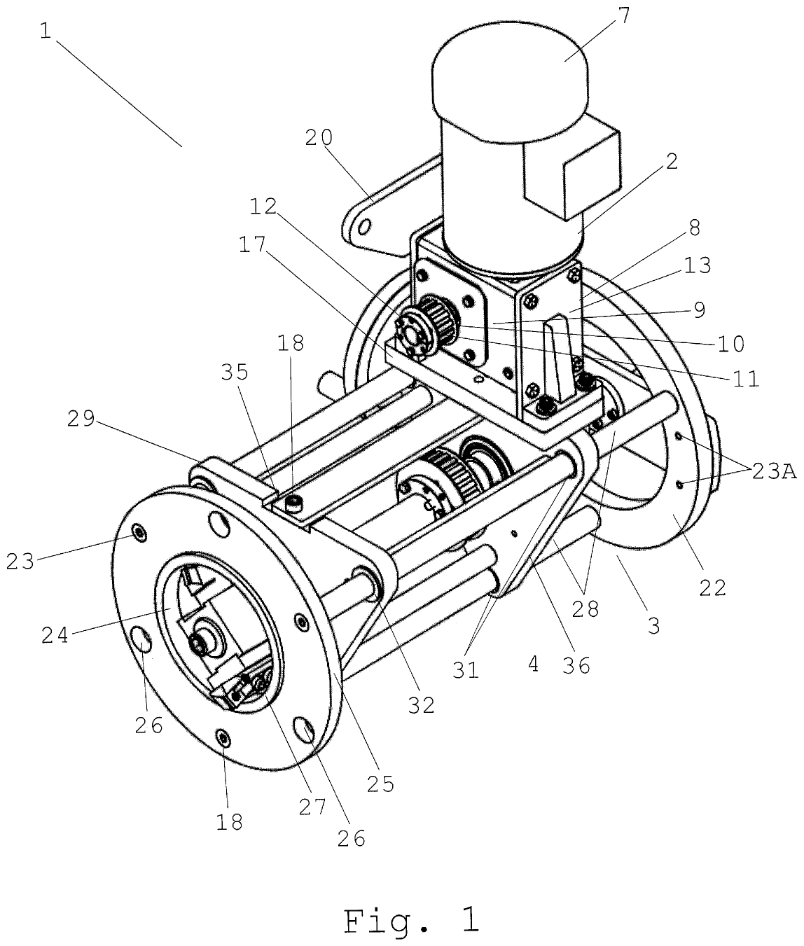

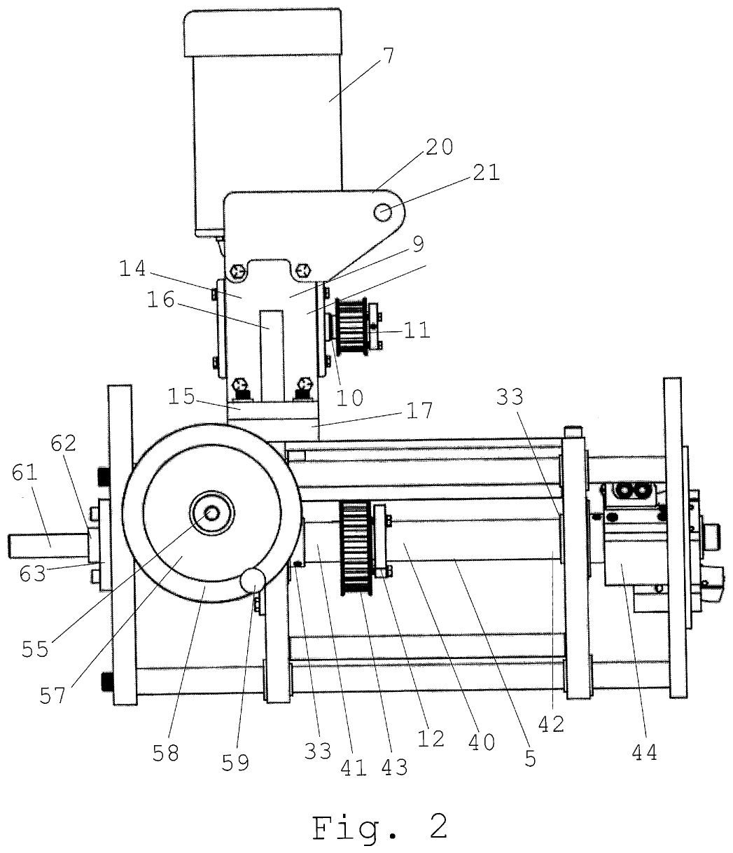

Referring to the drawings, FIGS. 1-4 depict a mobile resurfacing machine 1 having a drive assembly 2, cradle assembly 3, sled assembly 4, cutting assembly 5, and advancement assembly 6.

The mobile resurfacing machine 1 comprises a drive assembly 2 having a motor 7 which provides a rotational output. The motor 7 is preferably a variable speed electric motor, but internal combustion or other types of motors known in the art and in common use may be used. The motor 7 has a preferred power output of one- and one-half horsepower, but larger or smaller power outputs may be utilized. The drive assembly 2 further has a transmission assembly 8 which is coupled with and attached to the motor 7. The transmission assembly 8 has a speed reducer 9 which operates through gears or pulleys to take the rotational output supplied by the motor 7 such that the transmission output 10 rotates at a slower speed than rotational output of the motor 7. The use of the speed reducer served to reduce the speed of the motor output as well as increase torque. The output 10 is preferably an external shaft. The transmission assembly 8 also features a driver pulley 11 which is affixed to the output 10 and preferably secured with a taper lock 12. The transmission assembly 8 also features one or more foot assemblies 13 which serve to attach the transmission assembly 8 and, by extension the entire drive assembly 2, to the sled assembly. The foot assembly 13 has a first leg 14 which is oriented vertically, a second leg 15 which is oriented perpendicular to the first leg 14 such that the two form an L shape. The foot assembly further has a gusset 16 which is oriented to connect the first and second legs 14, 15 preferably as depicted in FIG. 1, 3, or 4. The first and second legs 14, 15 and the gusset 16 are rigidly affixed to one another. The transmission assembly also features a mounting plate 17 which is preferably of a generally rectangular shape. The foot assemblies and mounting plate are preferably made of steel, but other metals or other rigid materials may be used.

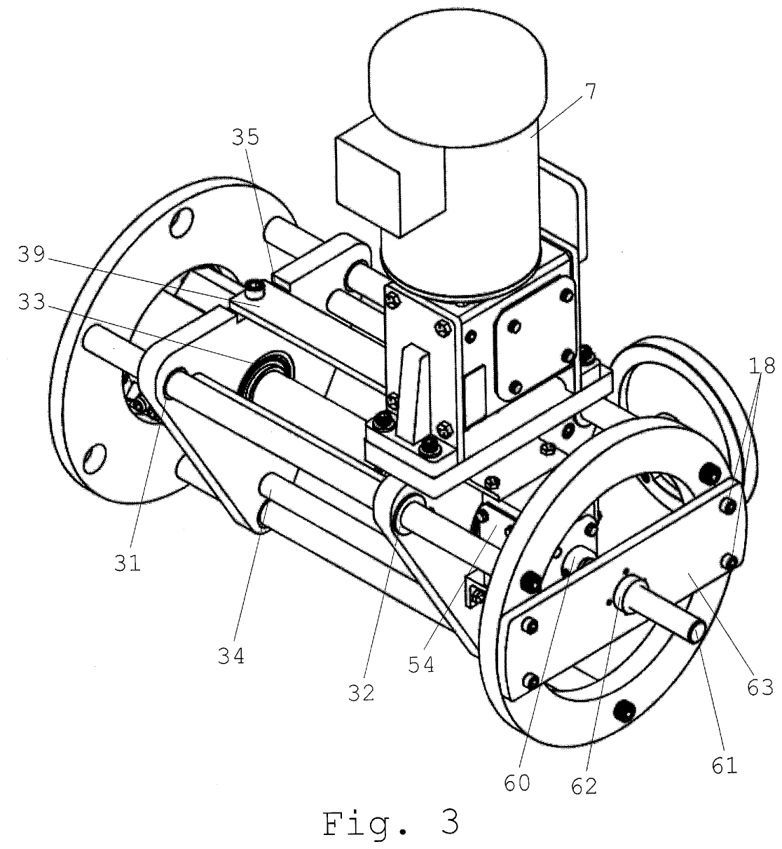

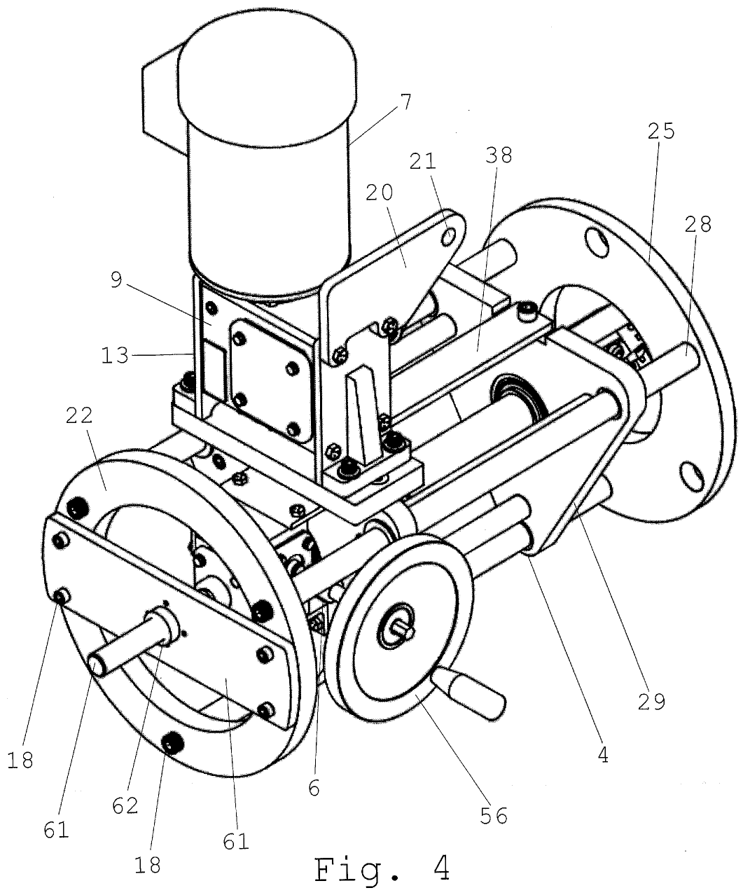

The drive assembly may also feature a drive link 19 which is configured to be attached to the driver pulley 11 to be connected to a driven pulley 52 of the cutting assembly 5. The drive link 19 is preferable a belt, but may also be a chain, gear drive, or other drive linkage known in the art. The drive assembly may also feature a lift plate 20 which is attached to the first leg 14 of a foot assembly 13. The lift plate 20 preferably has a generally trapezoidal shape as depicted in FIG. 4 but may take other shapes. The lift plate 20 features a lift hole 21 the lift plate is configured such that it is wider than the first leg 14 of the foot assembly 13 and attached as depicted in FIG. 4 such that the lift hole is located away from the motor and

The drive assembly 2 is assembled by attaching the motor 7 to the speed reducer 9 such that the motor 7 provides rotational force to the speed reducer 9. The driver pulley 11 is then affixed to the transmission output 10 and secured via a taper lock 12. One or more foot assemblies 13 are attached to a side of the speed reducer such that the first leg 14 is secured to the speed reducer as depicted in FIG. 1 via fasteners 18. The preferred fastener 18 is a bolt, but adhesives, screws, studs and nuts or other mechanical fasteners known in the art can be used. Each foot assembly 13 is then attached to the mounting plate 17 as depicted FIGS. 3-4 via fasteners 18.

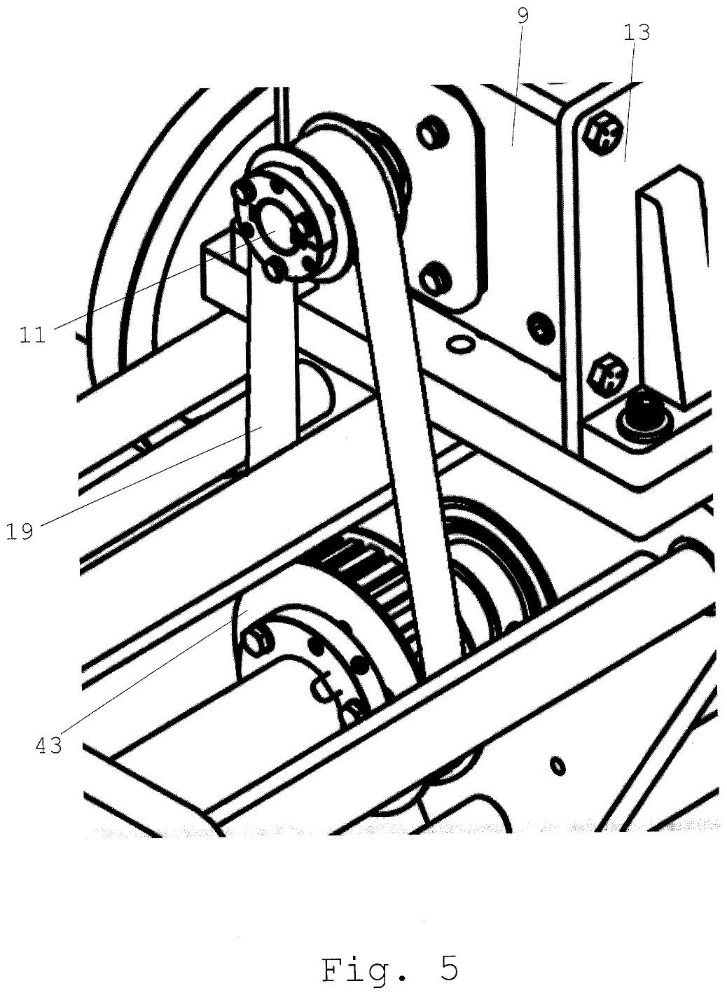

Referring to the drawings, FIGS. 1-4 show that the mobile resurfacing machine 1 further comprises a cradle assembly 3 having an outside flange 22, mounting flange 25, and guide shafts 28. The outside flange 22 is situated at the rear portion of the cradle assembly 3 features a plurality of assembly holes 23 which are spaced equidistant from the edge of the outside flange 22. The outside flange 22 may also feature a plurality of secondary assembly holes 23A. The outside flange 22 may also feature a central void 24. The preferred embodiment of the outside flange 22 is a circular ring structure with a central void 24, three assembly holes 23, and four secondary assembly holes 23A as depicted in FIGS. 6-7. However, other shapes, configurations, and numbers of holes may vary. The outside flange 22 is preferably made of steel, but other metals or other rigid materials may be used.

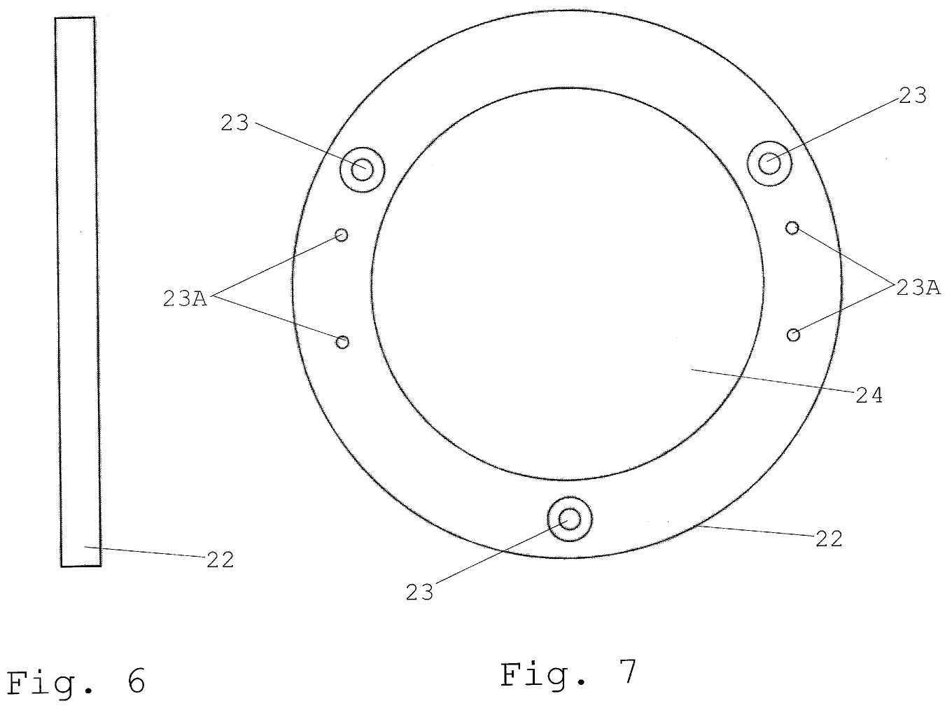

Referring to the drawings, FIGS. 1 and 8-9 depict a mounting flange 25. The mounting flange 25 is situated at the front of the cradle assembly 3 and features a plurality of assembly holes 23, a plurality of mounting holes 26, a central void 24, and an indexing ring 27. The assembly holes 23 are spaced equidistant from the edge of the mounting flange 25. The mounting holes 26 are preferably spaced concentrically around the center of the mounting flange 25 and are preferably configured such that they correspond in size and spacing to available mud pump fluid end modules. The indexing ring 27 it raised above the plane of the mounting flange 25 as depicted in FIG. 8. As depicted in FIG. 1, the indexing ring 27 is shaped such that is the same shape as the central void 24 and is located on the flange 25 immediately adjacent to the central void 24. The preferred embodiment of the mounting flange 25 is a circular ring structure with a central void 24, three assembly holes 23, three mounting holes, and a circular indexing ring 27 which is raised above the surface of the flange 25 and immediately proximate the central void 24 as depicted in FIGS. 8-9. However, other shapes, configurations, and numbers of holes may vary. The mounting flange 25 is preferably made of steel, but other metals or other rigid materials may be used.

Referring to the drawings, FIGS. 1-4 show that the cradle assembly 3 also features a plurality of guide shafts 28. The guide shafts 28 are preferably cylindrical and preferably substantially longer than their diameter. The guide shafts 28 preferably made of steel, but other metals or other rigid materials may be used. The guide shafts 28 may be drilled and tapped at their ends for purposes of assembling he cradle assembly 3.

In the preferred embodiment of the cradle assembly 3, three guide shafts 28 are affixed at one end to a ring-shaped outside flange 22 via fasteners 18 through the assembly holes 23 of the outside flange 22. A ring-shaped mounting flange 25 is attached via fasteners 18 to the unattached ends of the three guide shafts 28 such that the indexing ring is on the opposite side of the mounting flange 25 from the affixed guide shafts 28. The connections between the flanges and the guide shafts should be rigid such that there is no movement of play between the connections and the cradle assembly 3 is rigid.

The mobile resurfacing machine 1 further comprises a sled assembly 4 which comprises a forward bearing plate 29, rear bearing plate 36, a plurality of tie bars 37, and a stabilizer bar 38.

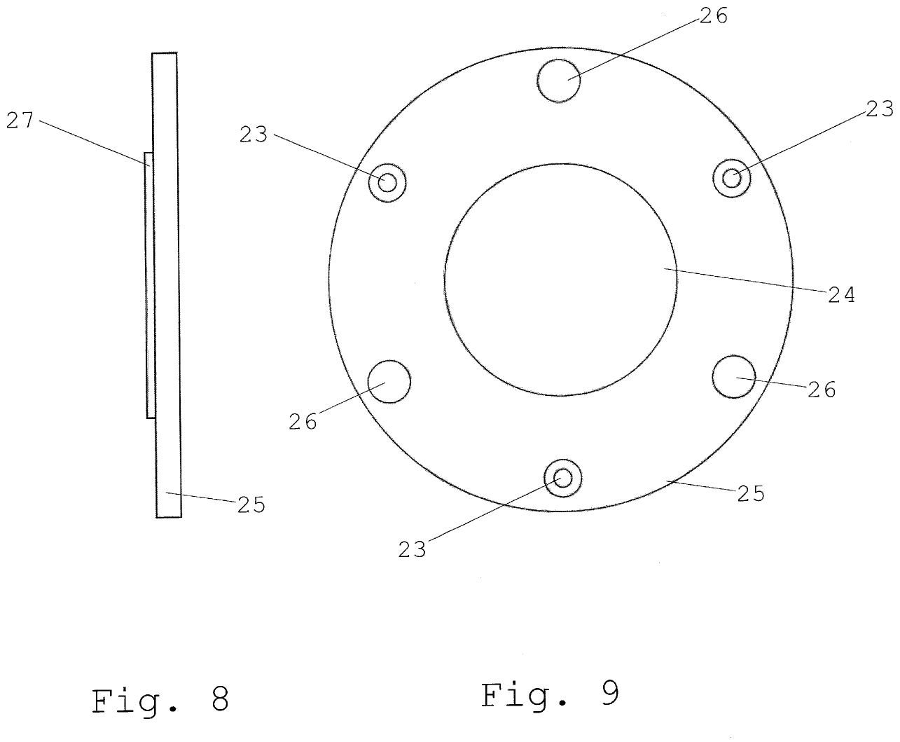

Referring to the drawings, FIGS. 10-11 depict a forward bearing plate 29. The forward bearing 29 plate is situated at the forward end of the sled assembly 4, which corresponds to the forward end of the cradle assembly 3. The forward bearing plate is preferably generally triangular or pentagonal in shape and preferably features rounded corners as depicted in FIGS. 10-11. The forward bearing plate 29 features a circular central bore 30 which is substantially centered in the plate 29. The forward bearing plate 29 also features a plurality of guide holes 31 which are preferably arranged concentrically around the central bore 30 and preferably arranged proximate the corners of the plate 29 as depicted in FIG. 10. The guide holes 31 are preferably circular. The guide holes must be and arranged such that they match with the guide shafts 28 of the cradle assembly 3. The forward bearing plate 29 may also feature a plurality of bushings 32. The bushings are preferably circular and have an outside diameter which corresponds to the diameter of the guide holes 31 and an inside diameter which corresponds to the diameter of the guide shafts 28. The forward bearing plate 29 may also have a bearing 33 which is sized to fit into the central bore. The forward bearing plate 29 further has a plurality of tie holes 34 which are preferably oriented such that they are spaced radially identical to the guide holes 31 and located radially inward from the guide holes 31. The forward bearing plate 29 further features a notch 35 in one of its sides as depicted in FIGS. 10-11. The forward bearing plate 29 is preferably made of steel, but other metals or other rigid materials may be used. The bushings 33 are preferably made of brass, but other materials known in the art for use as bushings may be used.

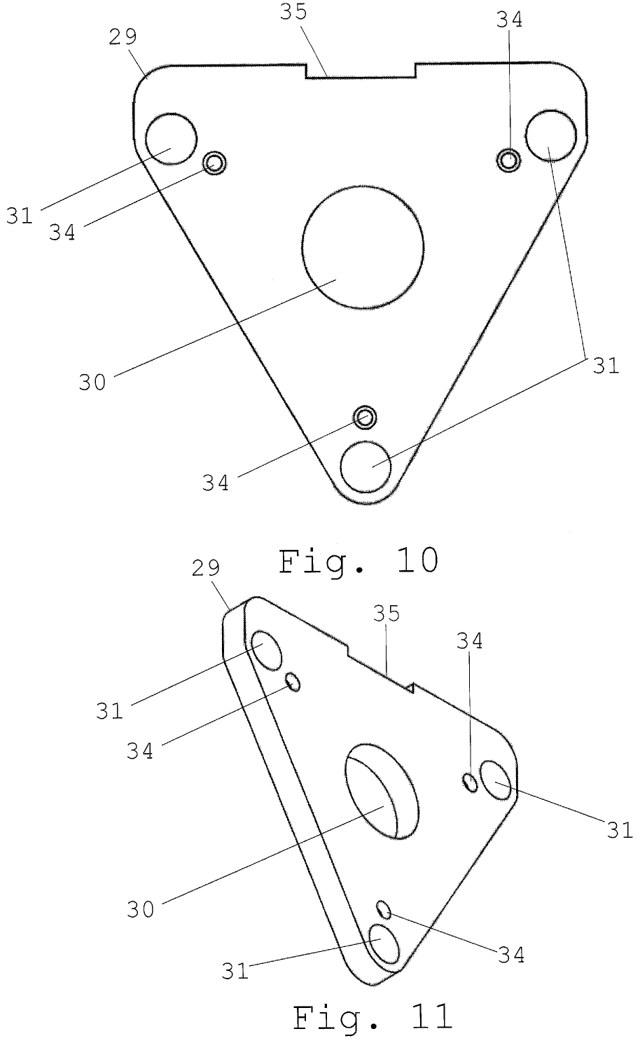

Referring to the drawings, FIGS. 12-13 depict a rear bearing plate 36. The rear bearing 29 plate is situated at the rear end of the sled assembly 4, which corresponds to the rear portion of the cradle assembly 3. The rear bearing plate is preferably generally triangular or pentagonal in shape and preferably features rounded corners as depicted in FIGS. 12-13. The rear bearing plate 36 features a circular central bore 30 which is substantially centered in the plate 36. The rear bearing plate 36 also features a plurality of guide holes 31 which are preferably arranged concentrically around the central bore 30 and preferably arranged proximate the corners of the plate 36 as depicted in FIG. 12. The guide holes 31 are preferably circular. The guide holes 31 must be and arranged such that they match with the guide shafts 28 of the cradle assembly 3 as well as those of the forward bearing plate. The rear bearing plate 36 may also feature a plurality of bushings 32. The bushings are preferably circular and have an outside diameter which corresponds to the diameter of the guide holes 31 and an inside diameter which corresponds to the diameter of the guide shafts 28. The rear bearing plate 36 may also have a bearing 33 which is sized to fit into the central bore 30. The rear bearing plate 36 further has a plurality of tie holes 34 which are preferably oriented such that they are spaced radially identical to the guide holes 31 and located radially inward from the guide holes 31. The rear bearing plate 36 is preferably made of steel, but other metals or other rigid materials may be used. The bushings 33 are preferably made of brass, but other materials known in the art for use as bushings may be used.

The sled assembly 4 also features a plurality of tie bars 37. The tie bars 37 are preferably cylindrical and preferably substantially longer than their diameter. The tie bars 37 preferably made of steel, but other metals or other rigid materials may be used. The tie bars 37 may be drilled and tapped at their ends for purposes of assembling he sled assembly 4. The sled assembly may also feature a stabilizer bar 39 as depicted in FIG. 1 which is generally rectangular in shape and configured to be affixed at one end to the notch 35 of the forward bearing plate 29 and to the underside of the mounting plate 17 of the drive assembly at the other end.

In the preferred embodiment of the sled assembly 4, three tie bars 37 are affixed at one end to the forward bearing plate 29 via fasteners 18 through the tie holes 34 of the forward bearing plate 29. The rear bearing plate 36 is attached via fasteners 18 to the unattached ends of the three tie bars 37 through the tie holes 34 of the rear bearing plate 36 and situated such that the notch 35 of the forward bearing plate is oriented upward. The stabilizer bar 39 is then affixed, at one end and to the notch 35 of the forward bearing plate 29 and will be affixed to the mounting plate 17, preferably to the underside of the mounting plate 17 of the drive assembly 2 at the other end when the machine 1 is assembled. Bearings 33 are then fit into the central bores 30 of the front and rear bearing plates 29, 36. The connections between the bearing plates and tie bars as well as between the mounting plate, stabilizer bar and bearing plates should be rigid such that there is no movement of play between the connections and the sled assembly 4 is rigid.

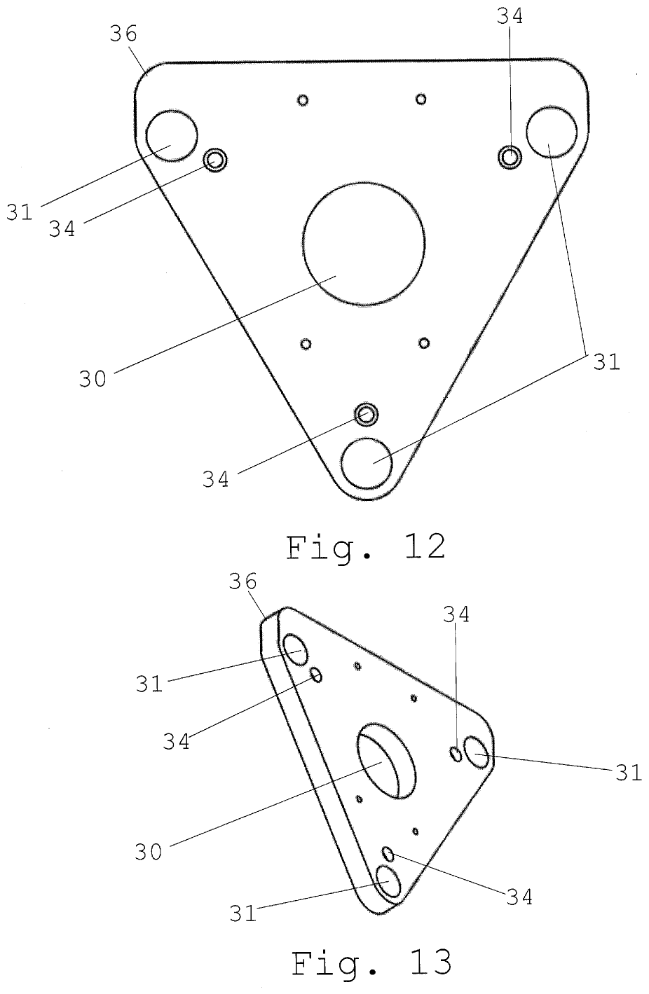

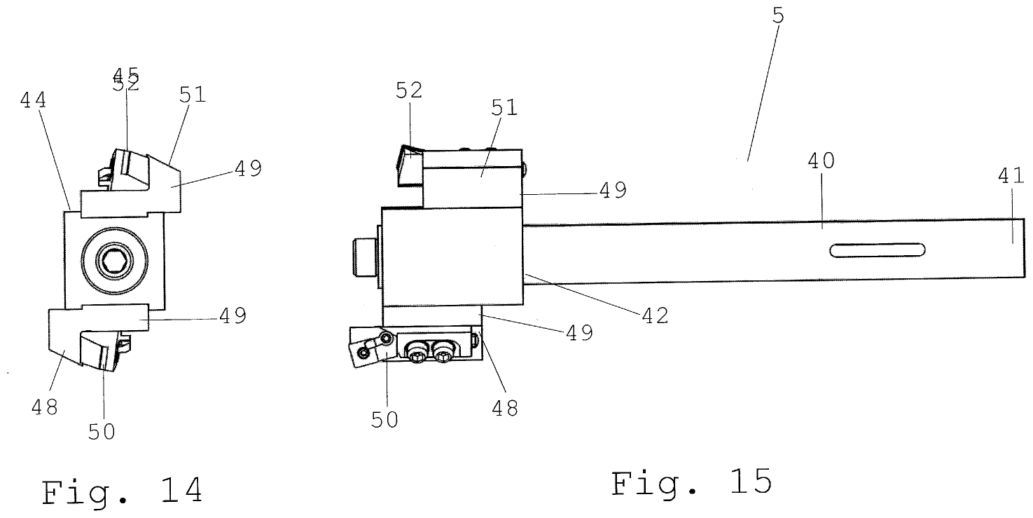

Referring to the drawings, FIGS. 14-15 depict a cutting assembly 5. The cutting assembly first comprises a drive shaft 40 which is generally cylindrical in form and is preferably substantially longer than its diameter. The drive shaft 40 has a rear end 41 and a forward end 42 The diameter of the drive shaft 40 should correspond to the inner diameter of the bearings 33 of the sled assembly. Affixed to the drive shaft is a driven pulley 43 proximate the rear end 41 which is preferably larger in diameter than the driver pulley 11 of the drive assembly 2. The driven pulley 41 is preferably secured in place with a taper lock 12.

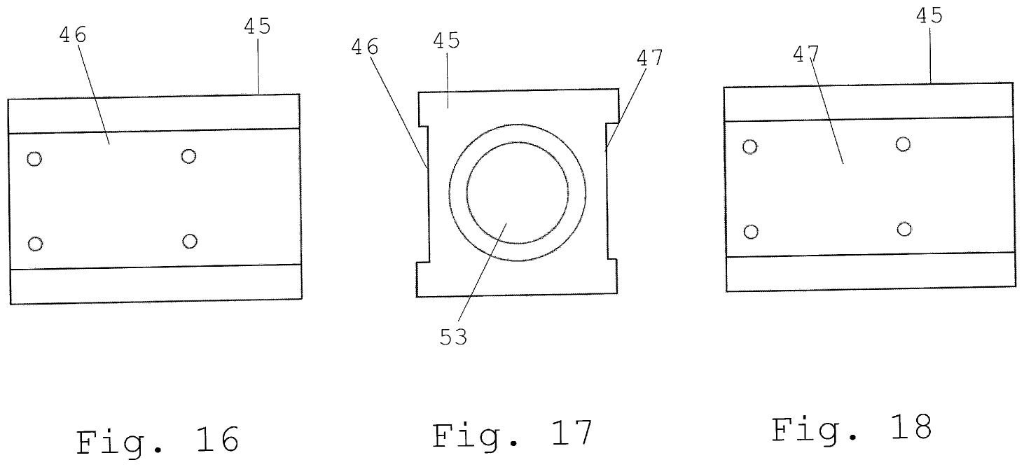

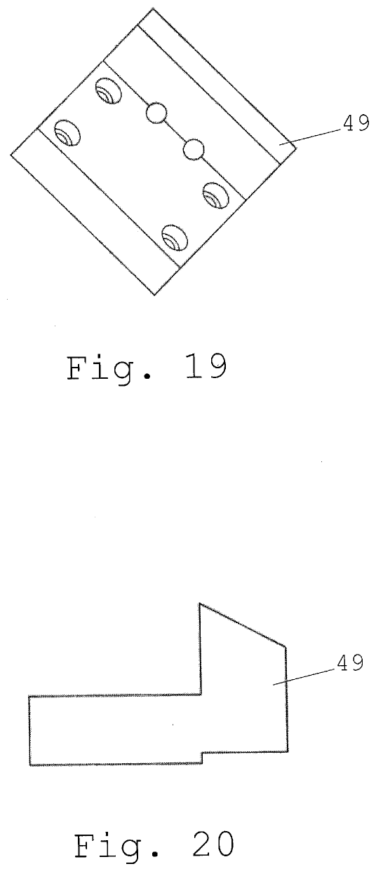

Affixed to the forward end 42 of the drive shaft 40 is a cutting head assembly 44. The cutting head assembly 44 has a central insert holder 45 with a first opposing side 46 and a second opposing side 47, and a fastener hole 53 located in the center of the insert holder as depicted in FIG. 17. Affixed to the first opposing side 46 is the rough-cut assembly 48 which comprises a cutting cartridge holder 49 and a rough-cut cartridge 50. The cutting cartridge holder 49 has a generally L shaped cross section and has a plurality of holes on one side such that it may be affixed to the central insert holder 45 via fasteners 18 and additional holes situated where the two planes of the L meet such that a cutting cartridge may be affixed to the cartridge holder via fasteners. Affixed to the second opposing side 47 is the finish-cut assembly 51 which comprises a cutting cartridge holder 49 and a finish-cut cartridge 52. The rough-cut cartridge 50 and finish-cut cartridge 52 are commercially available products and are known to those skilled in the art. When assembled, the central insert holder 45 is affixed to the forward end 42 of the drive shaft 40 via a fastener placed through the fastener hole 53. The finish-cut assembly 51 is affixed to the second opposing side 47 of the central insert holder 45 and is placed longitudinally closer to end of the drive shaft 40. The rough-cut assembly 48 is affixed to the first opposing side 46 of the central insert holder 45 and placed longitudinally farther from the end of the drive shaft 40. This assembly arrangement is depicted in FIG. 15 and results in the rough-cut assembly 48 being located forward of the finish-cut assembly 51. The drive shaft, central insert holder, and cutting inserts are preferably made of steel, but other metals or other rigid materials may be used.

The mobile resurfacing machine 1 further comprises an advancement assembly 6. Which is affixed to the rear bearing plate 36 of the sled assembly 4. The advancement assembly 6 may feature a transmission 54. The transmission features an input shaft 55 and an output 60. The preferred embodiment of the transmission is that the input shaft 55 and output 60 are oriented 90 degreed from one another such that the transmission is configured to transmit rotation of the input shaft 55 and transmit it to the output shaft. The transmission may operate through gear or linkage arrangements known in the art any may feature gear steps up or down such that the input shaft 55 and output rotate at different speeds. The transmission may also have an input source 56 to impart rotation of the input shaft 55. The input source may be manually operated or applied via motor or motorized tool. The preferred embodiment of the input source 56 is a hand wheel assembly 57 which is affixed to the input shaft 55 and features a wheel 58 which is oriented perpendicular to the input shaft 55 and a handle 59 which is placed on the face of the wheel 58, located proximate the outer edge of the wheel 58, and oriented perpendicular to the wheel 58. The wheel assembly 57 in its preferred embodiment is depicted in FIG. 4.

The advancement assembly 6 also features a lead screw 61 which is rotationally affixed to the transmission output 60 such that then rotation is applied to the input shaft 55, the output 60 and lead screw 61 rotate. The lead screw is a cylindrical threaded rod which is substantially longer than its diameter the advancement assembly also features a lead nut 62 which is affixed to the lead screw mounting plate 63. The lead nut 62 is a threaded nut with its inside diameter matched to the outside diameter of the lead screw 61 and its thread size and pitch matched to those of the lead screw 61. The lead screw mounting plate 63 is generally rectangular in shape in is dimensioned such that its width is approximately the same as that of the outside flange 22 of the cradle assembly 2. The lead screw mounting plate 63 also features a central hole a plurality of attachment holes 64 which are configured to match the arrangement of the secondary assembly holes 23A of the outside flange.

The advancement assembly 6 is configured such that the transmission is affixed to the rear bearing plate 26 on the side opposite the tie bars 37. The transmission is oriented such that the input shaft is oriented perpendicular to the longitudinal axis of the mobile resurfacing machine 1 and the output is oriented parallel perpendicular to the longitudinal axis of the mobile resurfacing machine 1 and situated such that the output is directed to the center of the outside flange 22. The lead screw mounting plate 63 is then affixed to the outside flange such that the central hole is in the center of the outside flange 22. The preferred method of affixing the lead screw mounting plate to the outside flange is via fasteners 18 through the attachment holes 64 and secondary assembly holes. However, the rear flange may be affixed by other means known in the art or may be an integral piece of the outside flange. The lead nut 62 is then affixed to the lead screw mounting plate 63 at the center of the plate such that the nut aligns with the plate's central hole. The lead screw 61 is then threaded into the lead nut 62 and advanced forward until the end of the lead screw 61 can be affixed to the transmission 54 output 60.

To assemble the mobile resurfacing machine 1, the different assemblies are put together as follows. The cradle assembly 3 is partially assembled such that the outside flange 22 is affixed to the guide shafts 27. The sled assembly 4 is then placed into the cradle assembly 3 by placing the guide shafts through the bushings 32 in the guide holes 31 of the rear bearing plate 36 and then through those of the forward bearing plate. The mounting flange 25 is then affixed to the unattached ends of the guide shafts such that the indexing ring 27 is on the side of mounting flange 25 opposite the guide shafts 27. The cutting assembly 5 is then attached to the sled assembly 4 by placing the rear end 54 of the drive shaft 51 through the central void 24 of the mounting flange 25 and through the bearings 33 of the central bore 30 of both the forward and rear bearing plates 29, 35. The driven pulley 52 should be placed on the drive shaft 51 loosely between the forward and rear bearing plates 29, 35. The drive shaft 51 should be secured in place by affixing it to the bearings. The transmission 54 is then affixed to the rear bearing plate 35 on the side opposite the tie bars 37. The lead nut 61 is affixed to the lead screw mounting plate 63, which is then affixed to the outside flange 22. The lead screw 61 is then advanced through the lead nut 62 until it meets and is affixed to the transmission output 60. The drive assembly 2, via the mounting plate 17 is then affixed to the sled assembly 4. The drive link 19 is then attached to the driver pulley 11 and the driven pulley 52 is adjusted on the drive shaft 51 such that it is immediately below the driver pulley 11 and the driven pulley 52 is secured in place with a taper lock 12. The drive link 19 is then attached to the driven pulley 52.

To use the mobile resurfacing machine 1, the transmission input source 56 is turned such that the advancement screw moves the sled assembly 4 and cutting assembly 5 rearward such that the end of the cutting head assembly 55 does not extend past the front of the mounting flange 25. The machine is placed on the cylinder opening of a fluid end module of a drilling mud pump. The indexing ring 27 is placed into the cylinder and the mounting flange 25 is placed flush against the module and oriented such that the mounting holes 26 line up with the holed on the face of the module. The Machine 1 is then bolted to the module through the mounting holes 26. Power is then applied motor 7, which begins to turn the cutting assembly 5. The transmission input source 56 is then turned such that the lead screw turns to advance the sled assembly 4 and cutting assembly 5 forward until the cutting head assembly 55 makes contact with the cylinder of the module, first with the rough-cut assembly 59 and followed by the finish-cut assembly 62. The input source 56 is then turned at a rate determined by the operator to advance the cutting head assembly 55 to the desired dept into the cylinder. Once the machine 1 has reached the desired resurfacing depth, the transmission input source 56 is turned in the opposite direction such that the cutting head is reversed until it no longer protrudes beyond the mounting flange 26. The motor 7 is then powered off and the machine can be removed from the module.

While this invention has been described with the specific embodiments outlines above, the preferred embodiments set forth are intended to be illustrative, not limiting. Various changes may be made without departing from the scope of the invention as defined in the following claims. The claims provide the scope of coverage of this invention and should not be limited to the specific examples cited above.

What is claimed is:

1. A mobile resurfacing machine configured to resurface the interior of cylinders comprising:
A cradle assembly comprising
An outside flange having a plurality of assembly holes, a plurality of secondary assembly holes, and a central void,
A mounting flange having a plurality of assembly holes having an identical arrangement and spacing as the assembly holes of the outside flange, a plurality of mounting holes, a central void, and an indexing ring, and
A plurality of guide shafts which are rigidly affixed to the outside flange and the mounting flange at the assembly holes of each via fasteners such that said outside flange and said mounting flange are affixed on opposite ends of the guide shafts;
A sled assembly comprising
A forward bearing plate having a circular central bore, a plurality of guide holes which are arranged and spaced identically to the assembly holes of the outside flange and the assembly holes of the mounting flange of the cradle assembly, a plurality of tie holes, and a notch,
A rear bearing plate having a circular central bore, a plurality of guide holes which are arranged and spaced identically to the assembly holes of the outside flange and the assembly holes of the mounting flange of the cradle assembly, and a plurality of tie holes,
A plurality of tie bars which are rigidly affixed to the forward bearing plate and the rear bearing plate at the tie holes of each via fasteners,
A plurality of bushings configured placed in the guide holed of the forward bearing plate and read bearing plate and sized such that the guide shafts of the cradle assembly can pass through said bushings, and
A stabilizer bar which is rigidly affixed to the notch of the forward bearing plate;
A drive assembly comprising
A motor,
A gearbox assembly, which is attached to the motor such that the motor provides a rotational input to the gearbox assembly, comprising a speed reducer, an output, a driver pulley affixed to the output, and a taper lock affixed to the driver pulley and the output and configured such that the driver pulley cannot rotate independently of the output,
A plurality of foot assemblies comprising a first leg, a second leg, and a gusset,
A mounting plate which is rigidly affixed to the foot assemblies which is configured to be affixed to the rear bearing plate and the stabilizer bar of the sled assembly such that the drive assembly is affixed to the sled assembly,
A drive link which is connected to the driver pulley of the gearbox assembly, and
A lift plate;
An advancement assembly affixed to the rear bearing plate of the sled assembly comprising
A transmission having an input shaft and an output that are oriented perpendicular to one another, and
An input source configured to apply rotational force to the input shaft,
A hand wheel assembly affixed to the input shaft having a wheel and a handle,
A lead screw which is affixed to the output of the transmission such that rotation of the output imparts an identical rotation on the lead screw,
A lead screw mounting plate which is affixed to the outside flange of the cradle assembly at the secondary assembly holes via fasteners and,
A lead nut which is affixed to the lead screw mounting plate and is sized to mate with the lead screw and is movably attached to the lead screw such that the lead screw may be threaded in and out of the lead nut;
A cutting assembly comprising
A drive shaft having a rear end and a forward end located to pass through the central bores of the front bearing plate and rear bearing plate of the sled assembly,
A driven pulley affixed to the drive shaft, said pulley being connected to the driver pulley of the drive assembly via the drive link,
A taper lock affixed to the driven pulley and the drive shaft and configured such that the driven pulley cannot rotate independently of the drive shaft,
A cutting head assembly affixed to the forward end of the drive shaft comprising
A central insert holder with a first opposing side and a second opposing side, and a fastener hole,
A rough-cut assembly affixed to the first opposing side having a cutting cartridge holder, and a rough-cut cartridge,
A finish-cut assembly affixed to the second opposing side and situated longitudinally rearward relative to the rough-cut assembly having a cutting cartridge holder, and a finish-cut cartridge.

2. A mobile resurfacing machine configured to resurface the interior of cylinders comprising:
A cradle assembly comprising
An outside flange having a plurality of assembly holes, a plurality of secondary assembly holes, and a central void,
A mounting flange having a plurality of assembly holes having an identical arrangement and spacing as the assembly holes of the outside flange, a plurality of mounting holes, a central void, and an indexing ring, and
A plurality of guide shafts which are rigidly affixed to the outside flange and the mounting flange at the assembly holes of each such that said outside flange and said mounting flange are affixed on opposite ends of the guide shafts;
A sled assembly comprising
A forward bearing plate having a circular central bore, a plurality of guide holes which are arranged and spaced identically to the assembly holes of the outside flange and the assembly holes of the mounting flange of the cradle assembly, a plurality of tie holes, and a notch,
A rear bearing plate having a circular central bore, a plurality of guide holes which are arranged and spaced identically to the assembly holes of the outside flange and the assembly holes of the mounting flange of the cradle assembly, and a plurality of tie holes,
A plurality of tie bars which are rigidly affixed to the forward bearing plate and the rear bearing plate at the tie holes of each, and
A stabilizer bar which is rigidly affixed to the notch of the forward bearing plate;
A drive assembly comprising
A motor,
A gearbox assembly, which is attached to the motor such that the motor provides a rotational input to the gearbox assembly, comprising a speed reducer, an output, and a driver pulley affixed to the output,
A plurality of foot assemblies comprising a first leg, a second leg, and a gusset,
A mounting plate which is rigidly affixed to the foot assemblies which is configured to be affixed to the rear bearing plate and the stabilizer bar of the sled assembly such that the drive assembly is affixed to the sled assembly, and
A drive link which is connected to the driver pulley of the gearbox assembly;
An advancement assembly affixed to the rear bearing plate of the sled assembly comprising
A transmission having an input shaft and an output that are oriented perpendicular to one another, and
An input source configured to apply rotational force to the input shaft,
A lead screw which is affixed to the output of the transmission such that rotation of the output imparts an identical rotation on the lead screw,
A lead screw mounting plate which is affixed to the outside flange of the cradle assembly and,
A lead nut which is affixed to the lead screw mounting plate and is sized to mate with the lead screw and is movably attached to the lead screw such that the lead screw may be threaded in and out of the lead nut;
A cutting assembly comprising
A drive shaft having a rear end and a forward end located to pass through the central bores of the front bearing plate and rear bearing plate of the sled assembly,
A driven pulley affixed to the drive shaft, said pulley being connected to the driver pulley of the drive assembly via the drive link,
A cutting head assembly affixed to the forward end of the drive shaft comprising
A central insert holder with a first opposing side and a second opposing side,
A rough-cut assembly affixed to the first opposing side having a cutting cartridge holder, and a rough-cut cartridge,
A finish-cut assembly affixed to the second opposing side and situated longitudinally rearward relative to the rough-cut assembly having a cutting cartridge holder, and a finish-cut cartridge.

3. A method for resurfacing a cylinder of a fluid end module of a drilling mud pump comprising the steps of:
Attaching to the cylinder opening of the fluid end module of a drilling mud pump a mobile resurfacing machine, which consists of a cradle assembly, a sled assembly, a drive assembly, an advancement assembly, and a cutting assembly with a rough-cut assembly placed forward of a finish-cut assembly, configured to rotate the cutting assembly and advance it into the cylinder opening;
Applying power to the motor assembly such that the motor assembly then rotates the cutting assembly;
Applying an input force to the advancement assembly such that the rotating cutting assembly is advanced into the cylinder such that the cylinder is resurfaced first by the rough-cut assembly and further resurfaced by the finish-cut assembly;
Applying a reversed force to the advancement assembly such that the cutting assembly is withdrawn from the cylinder;
Ceasing the power supplied to the motor assembly such that the motor and cutting assembly cease rotating; and
Removing the mobile resurfacing machine from the cylinder opening of the fluid end module of the drilling mud pump.
